(19) United States
(12) Patent Application Publication
(10) Pub. No.: US 2012/0313454 A1
(43) Pub. Date: Dec. 13, 2012

(54) POWER CONTROL DEVICE

(75) Inventor: Noah Montena, Syracuse, NY (US)

(73) Assignee: JOHN MEZZALINGUA ASSOCIATES, INC., East Syracuse, NY (US)

(21) Appl. No.: 13/155,421

(22) Filed: Jun. 8, 2011

(51) Int. Cl. H01H 7/00

(52) U.S. Cl. 307/115

(57) ABSTRACT

A power control device is disclosed which controls power shutdown and restart on an electrical power line. The power control device includes a first switch which couples and decouples a power input line to a first power output line in response to the switch being either closed or open, respectively. A power detection device detects whether the power input line is in the energized or non-energized state. When the power detection device detects that the power input line has transitioned from a non-energized state to an energized state, the power detection device sends a power restart indicator to a first timer. The first timer closes the first switch a first predetermined amount of time after receiving the power restart indicator In some embodiments a second switch, and second timer are included, where the second timer closes the second switch a second predetermined amount of time after receiving the power restart indicator.

### BACKGROUND OF THE INVENTION

1. Technical Field

This invention relates generally to power control devices and in particular to an electronic device which controls the timing of power flow through a power line.

2. State of the Art

Today's world is filled with electronic devices. Electronic devices control our offices, building, factories, stores, and homes. Electronic devices educate and amuse us. Electronic devices allow us to communicate with each other and with our homes, our vehicles and our finances. Each of these electronic devices requires power received from a power source. There are times when power is interrupted, and the electronic devices need to be restarted. In some systems there are a number of inter-related electronic devices which need to be restarted after a power outage. Devices can be plugged into power outlets with switches so that the power to the power outlet can be controlled by turning the switch on and off. If there are devices which require a particular timed restart sequence, however, this requires human intervention to plug the different devices into different power outlets and to control the switches manually after main power is restored. It is desirable to have a device which automatically controls power restart to one or more electronic devices in a timed manner.

### DISCLOSURE OF THE INVENTION

The present invention relates to power control devices and in particular to a device which controls the timing of power flow through a power line. Disclosed is a power control device which includes a power input line. The power input line is in one of either an energized state or a non-energized state. The power control device includes a switch. The switch repeatably electrically couples and decouples the power input line to a power output line in response to the switch being in a closed or an open position, respectively. The power control device also includes a power detection device coupled to the power input line, where the power detection device outputs a power restart indicator in response to the power detection device detecting that the power input line is in the energized state; and a timer electrically coupled to the power detection device, where the timer places the switch in the closed position a predetermined amount of time after the timer receives the power restart indicator from the power detection device. In some embodiments the power detection device places the switch in the open position in response to the power detection device detecting that the power input line is in a non-energized state. In some embodiments the power control device includes a power outlet coupled to the power output line. In some embodiment the predetermined amount of time is programmable.

In some embodiments the power control device includes an electronic device coupled to the power output line. In some embodiments the electronic device includes a second switch, where the second switch repeatably electrically couples and decouples the power output line to a power return line in response to the second switch being in a closed or an open position, respectively. In some embodiments the electronic device includes a second power detection device coupled to the power output line, where the second power detection device outputs a second power restart indicator in response to the second power detection device detecting that the power output line is in the energized state; and a second timer coupled to the second power detection device, where the second timer places the second switch in the closed position a second predetermined amount of time after the second timer receives the second power restart indicator from the second power detection device.

An electronic device is disclosed which includes a first switch, where the first switch repeatably electrically couples and decouples a power input line to a first power output line in response to the first switch being in a closed or an open position, respectively. The electronic device also includes a power detection device electrically coupled to the power input line, wherein the power detection device outputs a power restart indicator in response to the power detection device detecting that the power input line has transitioned from a non-energized state to an energized state. The electronic device also includes a first timer in electrical communication with the power detection device, wherein the first timer places the first switch in the closed position a first predetermined amount of time after the first timer receives the power restart indicator from the power detection device. In some embodiments the power detection device places the first switch in the open position in response to the power detection device detecting that the power input line has transitioned from the energized state to the non-energized state. In some embodiment the predetermined amount of time is programmable. In some embodiment the electronic device include a first power outlet, where the first power outlet receives power from the first power output line in response to the first switch being in the closed position.

In some embodiment the electronic device includes a second switch, where the second switch repeatably electrically couples and decouples the power input line to a second power output line in response to the second switch being in a closed or an open position, respectively. In some embodiments the electronic device includes a second timer in electrical communication with the power detection device, where the second timer places the second switch in the closed position a second predetermined amount of time after the second timer receives the power restart indicator from the power detection device. In some embodiments the power detection device places the first and the second switch in the open position in response to the power detection device detecting that the power input line has transitioned from an energized state to a non-energized state. In some embodiments the first predetermined amount of time is a different value than the second predetermined amount of time. In some embodiment the electronic device includes an electrical connector electrically coupled to the power input line, wherein the electrical connector repeatably electrically couples and decouples the power input line to a power source.

In some embodiments the electronic device includes a first electrical outlet electrically coupled to the first power output line, where the first electrical outlet receives electrical power in response to the first switch being in the closed position. In some embodiments the electronic device includes a second electrical outlet electrically coupled to the second power output line, where the second electrical outlet receives electrical power in response to the second switch being in the closed position.

A method of controlling power distribution is disclosed which includes the step of coupling a first power output line to a power input line with a first switch, wherein the first switch allows power to flow or restricts power from flowing from the power input line to the first power output line in response to the first switch being in a closed or an open position, respectively. The method of controlling power distribution according to the invention also includes the steps of generating a power restart indicator in response to detecting that the power input line has transitioned from a non-energized state to an energized state, and closing the first switch a first predetermined amount of time after receiving the power restart indicator.

In some embodiments the method of controlling power distribution according to the invention also includes the step of opening the first switch in response to detecting that the power input line has transitioned from an energized state to a non-energized state. In some embodiment the method includes the step of coupling a second power output line to the power input line with a second switch, where the second switch allows power to flow or restricts power from flowing from the power input line to the second power output line in response to the second switch being in a closed or an open position, respectively. In some embodiments the method of controlling power distribution according to the invention also includes the step of closing the second switch a predetermined amount of time after receiving the power restart indicator. In some embodiments the first predetermined amount of time is a different value than the second predetermined amount of time.

The foregoing and other features and advantages of the present invention will be apparent from the following more detailed description of the particular embodiments of the invention, as illustrated in the accompanying drawings.

### BRIEF DESCRIPTION OF THE DRAWINGS

FIG. 1 is a block diagram of one embodiment of power control device 110 according to the invention.

FIG. 2 is a state diagram of power detection device 118 of power control device 110 of FIG. 1.

FIG. 3 is a state diagram of timer 120 of power control device 110 of FIG. 1.

FIG. 4 is a state diagram of switch 116 of power control device 110 of FIG. 1.

FIG. 5 is a schematic diagram of one embodiment of power control device 110 according to the invention.

FIG. 6 is a schematic diagram of another embodiment of power control device 110 according to the invention.

FIG. 7 is a timing diagram for power control device 110 of FIG. 6.

FIG. 8 is a perspective drawing of one embodiment of power control device 110 of FIG. 6.

FIG. 9 is a front perspective view of another embodiment of power control device 110 according to the invention.

FIG. 10 is a schematic diagram of another embodiment of power control device 110 according to the invention.

FIG. 11 illustrates method 300 of controlling power distribution according to the invention.

### DETAILED DESCRIPTION OF EMBODIMENTS OF THE INVENTION

As discussed above, embodiments of the present invention relate to power control devices and in particular a device which controls the timing of power startup through a power line.

Electronic devices fill our offices, building, factories, stores, and homes. We use electronic devices every day to communicate with, control, and interact with the world around us. Each of these electronic devices requires power received from a power source. There are times when power is interrupted, and the electronic devices need to be restarted. In some systems there are a number of inter-related electronic devices which need to be restarted after a power outage, and often the electronic devices may need to be restarted in a particular timed sequence. A home network, for example, can include computers, modems, routers, switches, and voice over internet protocol (VOIP) adapters. If a power outage occurs, the various devices may need to be restarted in a timed sequence. A modem will need to establish contact with a internet service provider, for example, before the VOIP adapter can re-establish phone service. The disclosed invention is an electronic device that controls the power flow through a power line, and provides a means to delay the power restart for one device or a number of devices. The invention as described can be used to provide a power restart for a network of devices in a particular timed sequence.

The disclosed invention is an electronic power control device that includes a power input line, and one or more power output lines. A switch electrically couples each power output line to the power input line. A power detection device is used to detect the power status of the power input line. When the power input line is receiving power, the power input line is said to be in an energized state. When the power input line is not receiving power, the power input line is said to be in a non-energized state. The disclosed invention controls the flow of power from the power input line to the power output lines in response to detecting the state of the power input line. When one of the switches that connect the power input line to a power output line is closed, power flows from the power input line to the power output line. When the switch is open, power is restricted from flowing from the power input line to the power output line. When a power output line is receiving power, the power output line is said to be in an energized state. When a power output line is not receiving power, the power output line is said to be in a non-energized state.

The power detection device opens one or more switches when it detects that the power input line has lost power, meaning when the power input line is in a non-energized state. The disclosed invention also includes one or more timers which control when the switch or switches are closed again. Each switch is controlled by a timer. The power detection device outputs a power restart indicator when it detects that power has been restored to the power output line, meaning when the power input line has transitioned from a non-energized state to an energized state. The power restart indicator is in the form of a signal in some embodiments of the invention. In some embodiments the power restart indicator is in a form other than a signal. The power restart indicator is sent to each of the timers. The timers begin counting in response to receiving the power restart indicator. After each timer counts down its predetermined amount of time, it opens the switch associated with the timer. Each of the timers can be programmed to count down the same amount of time or different amounts of time.

One or more electrical devices can be connected to each of the power output lines. Each electrical device connected to a power output line will receive power whenever the switch associated with its power output line is closed. By appropriately setting the predetermined amount of time that each timer will count down for each individual electrical device, a set of electrical devices can have their power controlled such that their power restart sequence will be timed such that the device which must be restarted first, receives power first, and other devices which need the first device for their own restart sequence will not receive power until the first device is ready. In the home network discussed above, for example, the computer and modem can be programmed to receive power first, and given enough time to establish internet connection before the VOIP device is given power. The power control device according to the invention can includes multiple switches connecting in series, in parallel, or other combinations according to need. Each switch is controlled by a timer that is in electrical communication with a power detection device and the switch. In this way a power control device controls the flow of power to one or more power output lines, and in turn to one or more electrical devices coupled to the power output lines. The power control device is discussed in this document with regard to controlling the flow of electrical power, but it is to be understood that the power control device according to the invention as described can be used to control the flow of an electrical signal or any type of electrical charge that is transferred from one electrically conducting line to another electrically conducting line through a switch.

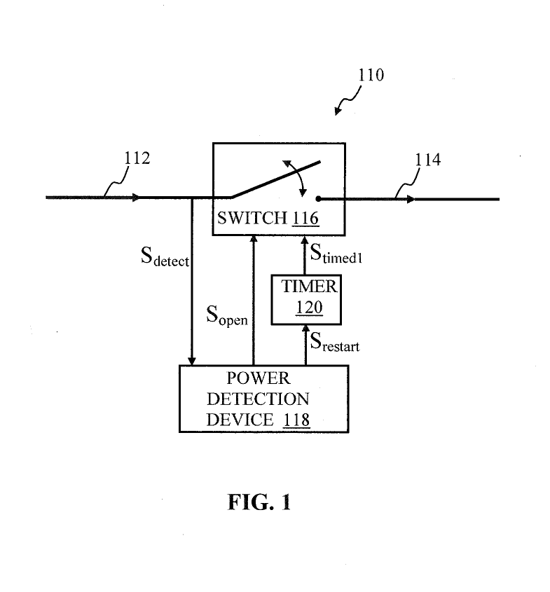

FIG. 1 shows one embodiments of power control device 110 according to the invention. Power control device 110 in this embodiment is an electronic device that includes power input line 112, power output line 114, and switch 116. Switch 116 repeatably electrically couples and decouples power output line 114 to power input line 112 in response to switch 116 being in a closed or an open position, respectively. Power input line 112 is a conductor which carries an electrical charge. The electrical charge can be in the form of an electrical signal or electrical power. Power input line 112 can be in one of two states, an energized state or a non-energized state. An energized state is when power input line 112 is carrying electrical charge on power input line 112. The energized state is also referred to as the “on” state or “HI” state of power input line 112. Power input line 112 can be in an energized state for many reasons. In some embodiments power input line 112 is in an energized state because it is receiving electrical power from a power source. In some embodiments power input line 112 is in an energized state because it is receiving voltage from a power source. In some embodiments power input line 112 is in an energized state because it is receiving current from a power source. In some embodiments power input line 112 is in an energized state because it is receiving a signal from a signal source. A power source can be any source of electrical charge, voltage, current, etc. A signal source can be any source of electrical signal. Power input line 112 can be in an energized state for any reason and can receive electrical power, an electrical signal, or other forms of electrical charge for any reason.

Power input line 112 is in a non-energized state when it is not carrying an electrical charge. This is also referred to as the “off” state or “LO” state of power input line 112. Power input line 112 is in a non-energized state when power input line 112 is not receiving or carrying electrical charge.

Power output line 114 is a conductor which carries an electrical charge. The electrical charge can be in the form of an electrical signal or electrical power. Power output line 114 can be in one of two states, an energized state or a non-energized state. An energized state is when power output line 114 is carrying electrical charge on power output line 114. Power output line 114 is in an energized state in response to receiving electrical charge in the form of electrical power or an electrical signal from power input line 112. Power output line 114 is in a non-energized state when it is not carrying an electrical charge.

Switch 116 repeatably electrically couples and decouples power output line 114 to power input line 112. Switch 116 can be in one of two states, an open state, or a closed state. When switch 116 is in the closed state, power output line 114 is electrically coupled to power input line 112. When switch 116 is in the closed state, and power input line 112 is in the energized state, power output line 114 receives electrical charge from power input line 112. When switch 116 is in the open state, power output line 114 is electrically decoupled (isolated) from power input line 112. When switch 116 is in the open state, and power input line 112 is in the energized state, power output line 114 receives no electrical charge from power input line 112. In some embodiments switch 116 needs electrical power to operate. Switch 116 can receive electrical power from any power source. In some embodiments switch 116 is battery powered. In some embodiments switch 116 receives electrical power from a power source.

Power control device 110 according to the invention includes power detection device 118. Power detection device 118 is coupled to power input line 112. Power detection device 118 detects which state, energized or non-energized, that power input line 112 is in. Power detection device 118 detects when power input line 112 transitions from an energized state to a non-energized state. And power detection device 118 detects when power input line 112 transitions from a non-energized state to an energized state. Power detection device 118 can detect the energized or non-energized state of power input line 112 is many ways. Power detection device 118 can detect when power input line 112 transitions from an energized state to a non-energized state and vice versa, in many ways. In this embodiment power detection device receives signal S_{detect} from power input line 112. Signal S_{detect} can be in one of two states, a HI state or a LO state. Signal S_{detect} mimics the power state of power input line 112. When power input line 112 is in an energized, or “HI” state, S_{detect} is in a HI state, When power input line 112 is in a non-energized, or “LO” state, S_{detect} is in a LO state. In this way power detection device 118 detects which power state, energized or non-energized, that power input line 112 is in. In some embodiments power detection device 118 needs electrical power to operate. Power detection device 118 can receive electrical power from any power source. In some embodiments power detection device 118 is battery powered. In some embodiments power detection device 118 receives electrical power from a power source.

When power input line 112 transitions from an energized state to a non-energized state, S_{detect} transitions from a HI state to a LO state. In this way power detection device 118 detects when power input line 112 transitions from an energized state to a non-energized state. When power input line 112 transitions from a non-energized state to an energized state, S_{detect} transitions from a LO state to a HI state. In this way power detection device 118 detects when power input line 112 transitions from a non-energized state to an energized state.

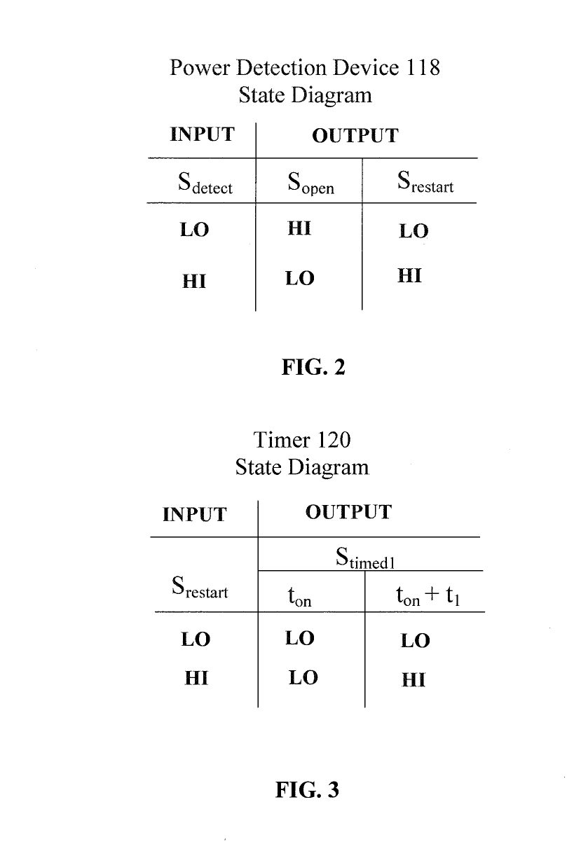

Power detection device 118 outputs two signals, Sₒₚₑₙ, and Sᵣₑₛₜₐᵣₜ. Sₒₚₑₙ is a signal used to open switch 116 when a power outage occurs, meaning when power input line 112 transitions from an energized state to a non-energized state. Sᵣₑₛₜₐᵣₜ is a power restart indicator which is used by power control device 110 to begin the power restart sequence once power has been restored to power input line 112, meaning when power input line 112 transitions from a non-energized state to an energized state. Sₒₚₑₙ and Sᵣₑₛₜₐᵣₜ can each be in either a HI or a LO state. The state of Sₒₚₑₙ and Sᵣₑₛₜₐᵣₜ depends on the state of S_{detect}. FIG. 2 shows a state diagram for power detection device 118 of FIG. 1. Sₒₚₑₙ and Sᵣₑₛₜₐᵣₜ are used by power control device 110 to control whether switch 116 should be closed to allow power to flow to power output line 114, or whether switch 116 should be opened to restrict power from flowing to power output line 114. When S_{detect} is in a LO state, meaning power input line 112 is in a non-energized state, then Sₒₚₑₙ is placed in a HI state by power detection device 118, and Sᵣₑₛₜₐᵣₜ is placed in a LO state. Sₒₚₑₙ being in a HI state will open switch 116, as will be discussed shortly. When power input line 112 is in a non-energized state, S_{detect} is in a LO state, power detection device 118 places Sₒₚₑₙ is in a HI state, and switch 116 remains in an open condition, restricting power from flowing to power output line 114 so that power restart can be controlled by power control device 110 once power line 112 transitions from a non-energized state to an energized state, as will be discussed shortly.

Power detection device 118 places Sₒₚₑₙ in a HI state, which places switch 116 in the open condition, in response to power detection device 118 detecting that power input line 112 is in the non-energized state. When power line 112 transitions from an energized state to a non-energized state, S_{detect} will transition from a HI state to a LO state. When S_{detect} transitions from a HI state to a LO state, power detection device 118 transitions Sₒₚₑₙ from a LO state to a HI state, which opens switch 116. In this way power detection device 118 opens switch 116 in response to power detecting device 118 detecting that power input line 112 has transitioned from an energized state to a non-energized state.

When S_{detect} is in a HI state, meaning power input line 112 is in an energized state, then Sₒₚₑₙ is placed in a LO state by power detection device 118, and Sᵣₑₛₜₐᵣₜ is placed in a HI state by power detection device 118. In a steady-state condition, when power input line 112 has been in an energized state for a long period of time, Sₒₚₑₙ remains in a LO steady-state condition, which allows switch 116 to remain closed. Sᵣₑₛₜₐᵣₜ and S_{timed1} (to be discussed shortly) are in a HI condition which allows switch 116 to remain closed. In this condition power output line 114 is electrically coupled to power input line 112 through switch 116, and electrical charge in the form of electrical power or an electrical signal flows from power input line 112 to power output line 114.

When power input line 112 transitions from a non-energized state to an energized state, power control device 110 controls the restart of power to power output line 114 by timing the closing of switch 116. In the embodiment shown in FIG. 1, when power input line 112 transitions from a non-energized state to an energized state, S_{detect} transitions from a LO state to a HI state. When S_{detect} transitions from a LO state to a HI state, Sᵣₑₛₜₐᵣₜ transitions from a LO state to a HI state, as shown in FIG. 2. In this embodiment of power control device 110 according to the invention, Sᵣₑₛₜₐᵣₜ transitioning from a LO state to a HI state is a power restart indicator. In this way power detection device 118 outputs a power restart indicator in the form of Sᵣₑₛₜₐᵣₜ in a HI state, in response to power detection device 118 detecting that power input line 112 is in an energized state. The power restart indicator, Sᵣₑₛₜₐᵣₜ transitioning from a LO state to a HI state, begins the timed restart process, which is explained in the following paragraphs.

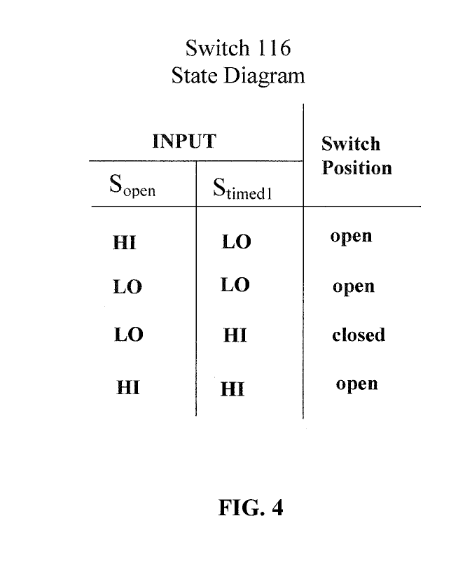

Power detection device 110 according to the invention includes a timer electrically coupled to the power detection device, where the timer places switch 116 in a closed position a predetermined amount of time after receiving the power restart indicator from power detection device 118. In the embodiment of power control device 110 of FIG. 1, power control device 110 includes timer 120. Timer 120 is electrically coupled to power detection device 118 and switch 116. Timer 120 outputs signal S_{timed1} in response to receiving signal Sᵣₑₛₜₐᵣₜ. FIG. 3 shows a state diagram of timer 120 of power control device 110 of FIG. 1. FIG. 4 shows a state diagram for switch 116. Timer 120 receives signal Sᵣₑₛₜₐᵣₜ from power detection device 118. Time tₒₙ is the point in time when power input line 112 transitions from a non-energized state to an energized state. At time tₒₙ, Sₒₚₑₙ transitions from a HI state to a LO state, and Sᵣₑₛₜₐᵣₜ transitions from a LO state to a HI state. Thus signal Sᵣₑₛₜₐᵣₜ transitions from a LO state to a HI state at time tₒₙ, indicating that power line 112 has transitioned from a non-energized state to an energized state. Timer 120 waits a predetermined amount of time t₁ after tₒₙ before taking any action. After waiting predetermined time t₁ after tₒₙ, timer 120 transitions S_{timed1} from a LO state to a HI state. When S_{timed1} transitions from a LO state to a HI state, and Sₒₚₑₙ is in a LO state, switch 116 closes in response (see FIG. 4). In this way timer 120 places switch 116 in a closed position predetermined amount of time t₁ after receiving a power restart indicator from power detection device 118, where the power restart indicator is Sᵣₑₛₜₐᵣₜ transitioning from a LO state to a HI state.

In some embodiments timer 120 needs electrical power to operate. Timer 120 can receive electrical power from any power source. In some embodiments timer 120 is battery powered. In some embodiments timer 120 receives electrical power from a power source.

FIG. 4 shows a state diagram for switch 116. Switch 116 receives and is controlled by two signals, Sₒₚₑₙ, which switch 116 receives from power detection device 118, and S_{timed1}, which switch 116 receives from timer 120. When Sₒₚₑₙ is in a HI state, indicating that power input line 112 is in a non-energized state, switch 116 is opened, decoupling power output line 114 from power input line 112. When both Sₒₚₑₙ is LO and S_{timed1} is LO, switch 116 is in an open position. When both Sₒₚₑₙ is LO and S_{timed1} is LO, power input line 112 has transitioned from a non-energized state to an energized state, but timer 120 has not finished counting out the predetermined amount of time t₁ that timer 120 waits after power restart before closing switch 116. So switch 116 remains open between time tₒₙ and time t₁. When Sₒₚₑₙ is LO and S_{timed1} is HI, switch 116 closes, electrically coupling power output line 114 to power input line 112, and allowing electrical charge to flow from power input line 112 to power output line 114. When Sₒₚₑₙ is LO and S_{timed1} is HI, power input line is in an energized state (thus Sₒₚₑₙ is LO) and timer 120 has completed waiting predetermined amount of time t₁, thus transitioning S_{timed1} from a LO state to a HI state, and closing switch 116. In this way timer 120 places switch 116 in a closed position predetermined amount of time t₁ after receiving a power restart indicator from power detection device 118, where the power restart indicator is Sᵣₑₛₜₐᵣₜ transitioning from a LO state to a HI state.

It is to be understood that power control device 110 according to the invention can be implemented with any type of switch, power detection device, and timer. In some embodiments the state diagrams of the switch, power detection device, and timer are different than those shown in FIG. 2 through FIG. 4. Switch 116, timer 120, and power detection device 118 can be implemented using any type of discrete or integrated technology. In some embodiments other signals are used to trigger activity of power control device 110.

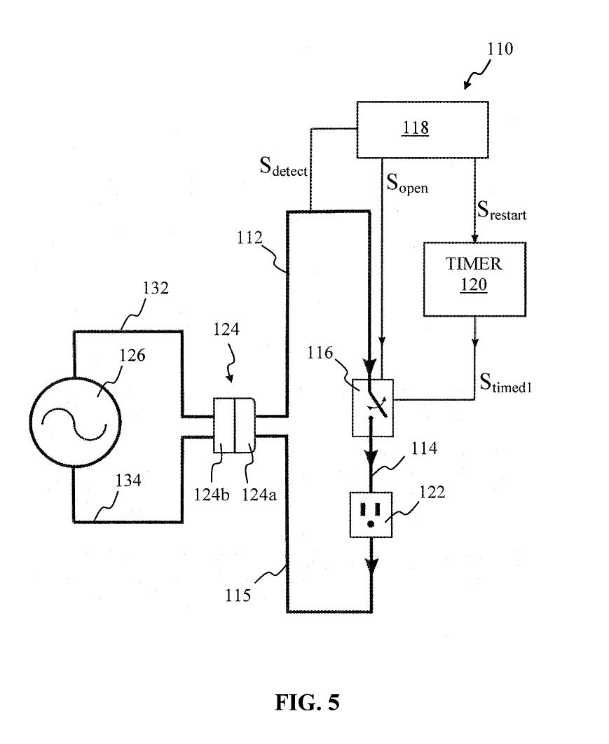

FIG. 5 shows another embodiment of power control device 110 according to the invention. This embodiment includes all of the elements of electronic device 110 according to the invention of FIG. 1, including power input line 112, power output line 114, power detection device 118, timer 120, and switch 116. These elements all operate as explained with regard to FIG. 1 through FIG. 4. Power control device 110 in the embodiment shown in FIG. 5 also includes electronic device 122 coupled to power output line 114. Electronic device 122 is coupled to power output line 114 and power return line 115. In this embodiment electronic device 122 is an electrical outlet. When power line 114 is in an energized state, electrical outlet 122 receives power from power output line 114. Power output line 114 is in an energized state when power input line 112 is in an energized state and switch 116 is in a closed position. Thus electrical outlet 122 is receiving power when power input line 112 is in an energized state and switch 116 is in a closed position. When switch 116 is in an open position, power output line 114 and electrical outlet 122 are not receiving power from power input line 112. In this embodiment electrical device 122 is an electrical outlet. In this embodiment whatever device, product, machine, or other electrical thing is plugged into electrical outlet 122 will receive power when power input line 112 is in an energized state and when switch 116 is in a closed position. In some embodiments electrical device 122 is an electrical device other than an electrical outlet.

In the embodiment of power control device 110 shown in FIG. 5, power control device 110 is connected to power source 126 through connector 124, main power input line 132, and main power output line 134. Power source 126 can be any type of power source. In some embodiments power source 126 is the electrical power received to a household or business through power lines and distributed throughout buildings with power lines and power outlets. In some embodiments power source 126 is a power supply. In some embodiments power supply 126 is a direct current (DC) source of power, as opposed to the alternating current (AC) source shown in FIG. 5. In some embodiments power source 126 is a battery. Power source 126 can be any source of electrical power supplied to main power lines 132 and 134. In this embodiment main power lines 132 and 134 carry electrical power from power source 126 to connector 124. In this embodiment power source 126 is building power from AC power lines, and connector 124 is a wall outlet and plug. Connector 124 includes connector halves 124a and 124b. Connector 124b is wall outlet 124b, and connector 124a is plug 124a, which plugs into wall outlet 124b to deliver power to electrical outlet 122. In this embodiment power control device 110 is part of an electrical extension cord which includes electrical outlet 122.

Power control device 110 in the embodiment shown in FIG. 5 controls the delivery of power to electrical outlet 122 such that when power input line 112 transitions from an energized state to a non-energized state, S_{detect} transitions from a HI state to a LO state, as described with respect to FIG. 1. Power detection device 118 switches Sₒₚₑₙ from a LO state to a HI state, and Sᵣₑₛₜₐᵣₜ from a HI state to a LO state in response to S_{detect} transitioning from a HI state to a LO state, as shown in FIG. 2. Switch 116 transitions from a closed position to an open position in response to Sₒₚₑₙ transitioning from a LO state to a HI state, as shown in FIG. 4. In this way power detection device 118 places switch 116 in the open position in response to power detection device 118 detecting that power input line 112 is in a non-energized state. In this way power detection device 118 places switch 116 in the open position in response to power detection device 118 detecting that power input line 112 has transitioned from the energized state to the non-energized state.

Power input line 112 can lose power for any reason. In some embodiments power input line 112 loses power because power source 126 is shut off. In some embodiments power input line 112 loses power because connector 124 is disconnected. In some embodiments power input line 112 loses power because a break occurs in one of the power lines delivering power to power input line 112. In some embodiments power input line 112 loses power because power is shut off purposely to power input line 112. In some embodiments power input line 112 loses power because of an unplanned power interruption. Similarly, power line 112 can have power restored for any reason. Power input line 112 can have power restored purposely. In some embodiments power input line has power restored because a problem with power delivery is fixed.

When power input line 112 regains power, meaning when power input line 112 transitions from a non-energized state to an energized state, power control device 110 controls the timing of when electrical outlet 122 will receive power again, as explained with respect to FIG. 1 through FIG. 4. When power input line 112 transitions from a non-energized state to an energized state, S_{detect} transitions from a LO state to a HI state. When S_{detect} transitions from a LO state to a HI state, power detection device 118 places Sₒₚₑₙ in a LO state, and Sᵣₑₛₜₐᵣₜ in a HI state, as shown in FIG. 2. Transitioning Sᵣₑₛₜₐᵣₜ to a HI state is a power restart indicator that is output by power detection device 118. Power detection device 118 outputting the power restart indicator, in the form of placing Sᵣₑₛₜₐᵣₜ in a HI state, begins the power restart sequence. In this way power detection device 118 outputs a power restart indicator in response to power detection device 118 detecting that power input line 112 is in the energized state. In this way power detection device 118 outputs a power restart indicator in response to power detection device 118 detecting that power input line 112 has transitioned from a non-energized state to an energized state.

Switch 116 does not respond to the transition of Sₒₚₑₙ from a HI state to a LO state, as shown in FIG. 4. When power detection device outputs the power restart indicator, which in the embodiment of power control device 110 shown in FIG. 5 is Sᵣₑₛₜₐᵣₜ transitioning from a LO state to a HI state, and occurs at time tₒₙ, timer 120 begins counting to predetermined time t₁. After waiting predetermined time t₁, timer 120 transitions S_{timed1} from a LO state to a HI state, as shown in FIG. 3. Switch 116 closes in response to S_{timed1} transitioning from a LO state to a HI state, and Sₒₚₑₙ being in a LO state, as shown in FIG. 4. In this way timer 120 places switch 116 in the closed position a first predetermined amount of time t₁ after receiving the power restart indicator from power detection device 118, where the power restart indicator is Sᵣₑₛₜₐᵣₜ transitioning from a LO state to a HI state.

Switch 120 closing electrically couples power output line 114 to power input line 112, which restores electrical power to power output line 114 and to power outlet 122. If an electrical product or device is connected to electrical outlet 122, it will be restored to power predetermined time t₁ after power input line 112 transitions from a non-energized state to an energized state. In this way timer 120 restores power to electrical device 122 a predetermined amount of time t₁ after timer 120 receives the power restart indicator from power detection device 118.

Electronic device 110 according to the invention, which in the embodiment shown in FIG. 5 is in the form of power control device 110, controls the timing of power restart for whatever electronic device is plugged into electrical outlet 122. When power input line 112 loses power—transitions from an energized state to a non-energized state—power detection device 118 will open switch 116 in response. When power input line 112 regains power, S_{detect} will transition from a LO state to a HI state. Power detection device 118 detects that power line 112 has regained power by detecting that S_{detect} has transitioned from a LO state to a HI state. Power detection device outputs a power restart indicator in response to detecting that power input line 112 has transitioned from a non-energized state to an energized state. The power restart indicator in this embodiment is in the form of Sᵣₑₛₜₐᵣₜ transitioning to a HI state. The power restart indicator, in the form of Sᵣₑₛₜₐᵣₜ transitioning to a HI state, is received by timer 120. Timer 120 places switch 120 in the closed position predetermined amount of time t₁ after receiving the power restart indicator from power detection device 118. Switch 120 closing couples power output line 114 to power input line 112, providing power to both power output line 114 and electrical outlet 122. Thus the electronic device plugged into electrical outlet 122 receives power a predetermined amount of time t₁ after power is restored to power input line 112. In some embodiment predetermined amount of time t₁ is adjustable. In some embodiments predetermined amount of time t₁ is programmable.

The device plugged into electrical outlet 122 can need power restart control for many different reasons. In some embodiment the electronic device plugged into electrical outlet 122 may need to stay in a power down condition for some amount of time after power has been turned off. In some embodiments there are other reasons for requiring that the electronic device plugged into electrical outlet 122 stay off for a predetermined amount of time t₁ after power is restored to power input line 122.

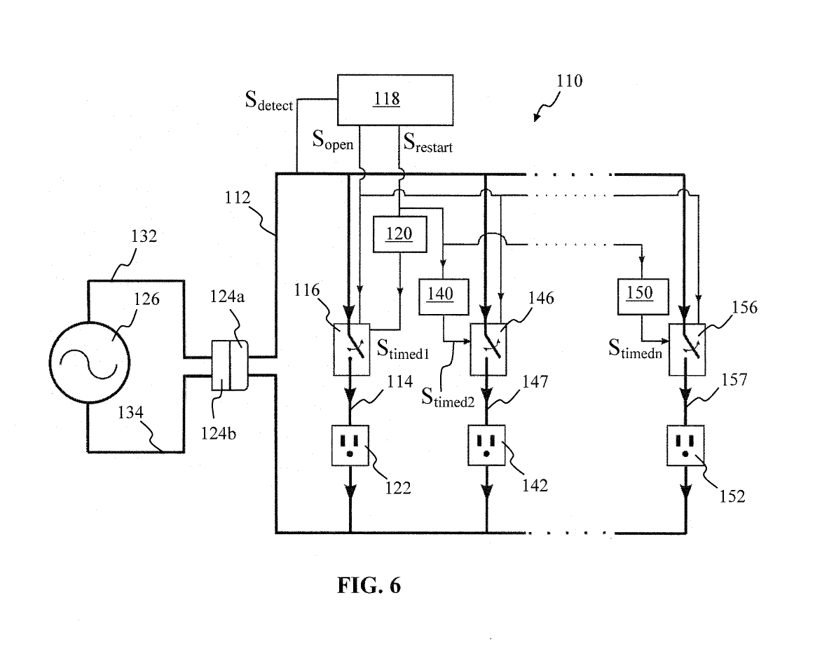

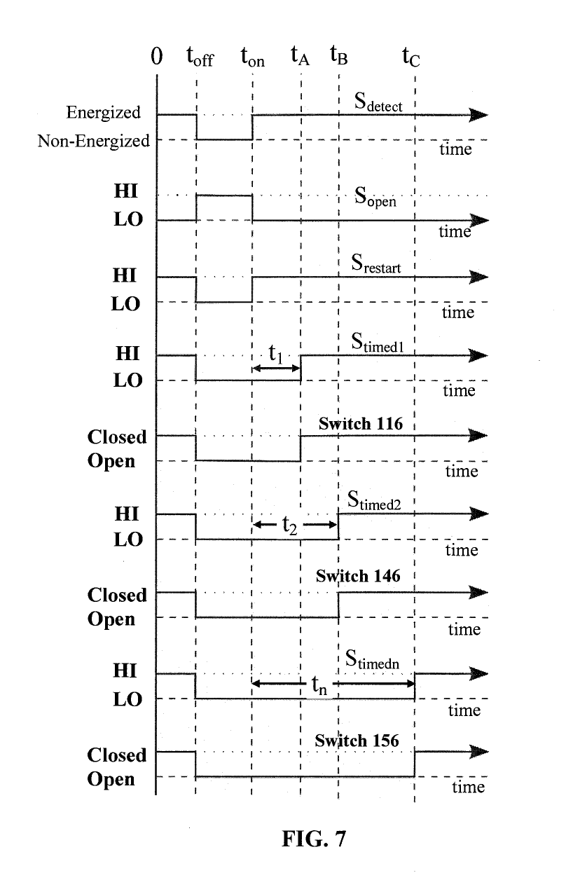

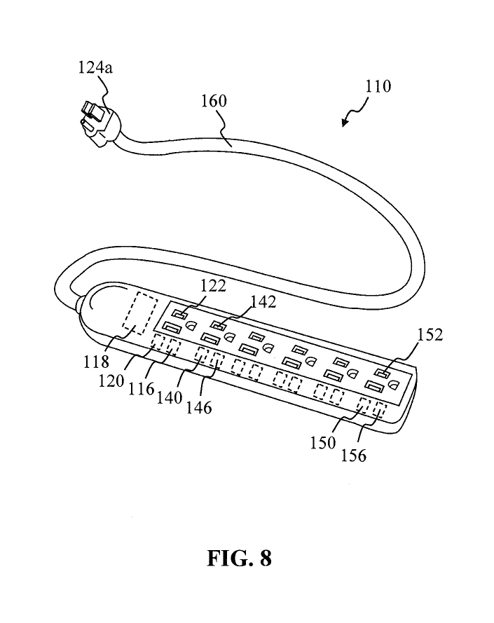

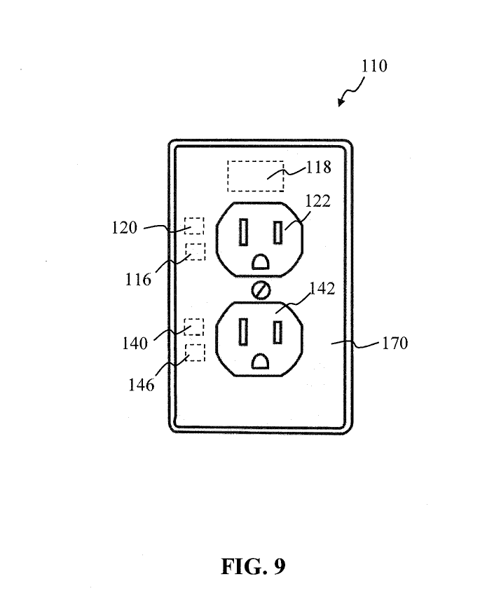

In some embodiments a group of electronic devices is a part of a network in which power restart timing is advantageous because some of the network items need communication with others on the network in order to restart properly. Many homes and businesses have groups of electronic devices which are interrelated and rely on each other throughout a power restart sequence, such as the home network which includes the VOIP device discussed earlier. In these situations power control device 110 according to the invention can be used to control the power restart sequence for a group of electronic devices. FIG. 6 through FIG. 8 show an example of an embodiment of power control device 110 which can be used to control the power restart sequence for a group of electronic devices. FIG. 6 shows a block diagram of an embodiment of power restart device 110 according to the invention. FIG. 7 shows the timing diagram of the signals used in power control device 110 according to the invention of FIG. 6. FIG. 8 shows a perspective view of one embodiment of power control device 110 of FIG. 6. In this embodiment power control device 110 takes the form of a power strip with multiple power outlets, as shown in FIG. 8.

Power control device 110 of FIG. 6 includes plug 124a, which can plug into any mating connector 124b to receive power from power source 126, and main power input and output lines 132 and 134. In some embodiments connector 124b is a wall outlet which provides power to power control device 110 through plug 124a. Power control device 110 in this embodiment includes first electronic outlet 122, second electronic outlet 142, and nth electronic outlet 152. In the embodiment of power control device 110 shown in FIG. 8, there are three electronic outlets in between second electronic outlet 142 and nth electronic outlet 152. In power control device 110 according to the invention there can be any number of outlets in between second electronic outlet 142 and nth electronic outlet 152, as indicted in FIG. 6.

In the embodiment of power control device 110 according to the invention shown in FIG. 6 through FIG. 8, power to each electronic outlet is controlled by a switch associated with each individual electrical outlet. Each switch is connected in series between power input line 112 and a power output line. First switch 116 couples and decouples power input line 112 and first power output line 114, as discussed with respect to FIG. 1 through FIG. 5. First electrical outlet 122 is coupled to first power output line 114 such that when first power output line 114 is in an energized state, first electrical outlet 122 receives electrical power, as discussed with respect to FIG. 5.

Second switch 146 couples and decouples power input line 112 and second power output line 147 in response to second switch 146 being in a closed or an open position, respectively. Second electrical outlet 142 is coupled to second power output line 147 such that when second power output line 147 is in an energized state, second electrical outlet 142 receives electrical power. In this way power control device 110 in the embodiment shown in FIG. 6 includes second switch 146, where second switch 146 repeatably electrically couples and decouples power input line 112 to second power output line 147 in response to second switch 146 being in a closed or an open position, respectively.

Nth switch 156 couples and decouples power input line 112 and nth power output line 157 in response to nth switch 156 being in a closed or an open position, respectively. Nth electrical outlet 152 is coupled to nth power output line 157 such that when nth power output line 157 is in an energized state, nth electrical outlet 152 receives electrical power. In some embodiments there are additional sets of switches and electrical outlets.

Power detection device 118 in the embodiment shown in FIG. 6 through FIG. 8 is coupled to first switch 116, second switch 146, nth switch 156, and any switches in between, with signal Sₒₚₑₙ, such that power detection device 118 places all the switches in the open position in response to power detection device 118 detecting that power input line 112 has transitioned from an energized state to a non-energized state, as discussed earlier with respect to FIG. 1 through FIG. 5. In this way power detection device 118 places first switch 116 and second switch 116 in the open position in response to power detection device 118 detecting that power input line 112 has transitioned from an energized state to a non-energized state.

FIG. 7 shows a timing diagram of power control device 110 of FIG. 6. Time t_{off} is the point in time that power input line 112, and S _{detect}, transition from an energized state to a non-energized state. Time tₒₙ is the point in time that power input line 112, and S_{detect}, transition from a non-energized state to an energized state. Time t_{A} is the point in time that first timer 120 closes first switch 116. Time t_{A} is equal to tₒₙ+predetermined amount of time t₁, as explained with respect to FIG. 1 through FIG. 5. Time t_{B} is the point in time that second timer 140 closes second switch 146. Time t_{B} is equal to tₒₙ+predetermined amount of time t₂, as will be explained shortly. Time t_{C} is the point in time that nth timer 150 closes nth switch 156. Time t_{C} is equal to tₒₙ+predetermined amount of time tₙ, as will be explained shortly.

Each switch has a timer electrically coupled to it. First switch 116 is electrically coupled to power detection device 118 and first timer 120, as discussed with respect to FIG. 1 through FIG. 5. First timer 120 is coupled to first switch 116 such that first timer 120 closes first switch 116 a first predetermined amount of time t₁ after timer 120 receives a power restart indicator from power detection device 118, where the power restart indicator is Sᵣₑₛₜₐᵣₜ transitioning from a LO state to a HI state, as discussed earlier. First timer 120 closes first switch 116 by transitioning S_{timed1} from a LO state to a HI state. Sᵣₑₛₜₐᵣₜ transitions from a LO state to a HI state at time tₒₙ. First timer 120 transitions signal S_{timed1} from a LO state to a HI state first predetermined amount of time t₁ after tₒₙ, which occurs at time t_{A} in the timing diagram shown in FIG. 7. Time t_{A} is equal to tₒₙ+first predetermined amount of time t₁. First switch 116 is closed by first timer 120 at time t_{A}.

Second switch 146 is electrically coupled to power detection device 118 and second timer 140. Second timer 140 is coupled to second switch 146 such that second timer 140 closes second switch 146 a second predetermined amount of time t₂ after second timer 140 receives a power restart indicator from power detection device 118, where the power restart indicator is Sᵣₑₛₜₐᵣₜ transitioning from a LO state to a HI state, as discussed earlier. Second timer 140 closes second switch 146 by transitioning signal S_{timed2} from a LO state to a HI state, as shown in FIG. 7. Sᵣₑₛₜₐᵣₜ transitions from a LO state to a HI state at time tₒₙ. Second timer 140 transitions signal S_{timed2} from a LO state to a HI state second predetermined amount of time t₂ after tₒₙ, which occurs at time t_{B} in the timing diagram shown in FIG. 7. Time t_{B} is equal to tₒₙ+second predetermined amount of time t₂. Second switch 116 is closed by second timer 140 at time t_{B}. In this way power control device 110 according to the invention includes second timer 140, where second timer 140 places second switch 146 in the closed position second predetermined amount of time t₂ after second timer 140 receives the power restart indicator from power detection device 118, where the power restart indicator is Sᵣₑₛₜₐᵣₜ transitioning from a LO state to a HI state.

Nth switch 156 is electrically coupled to power detection device 118 and nth timer 150. Nth timer 150 is coupled to nth switch 156 such that nth timer 150 closes nth switch 156 an nth predetermined amount of time tₙ after nth timer 150 receives a power restart indicator from power detection device 118, where the power restart indicator is Sᵣₑₛₜₐᵣₜ transitioning from a LO state to a HI state, as discussed earlier. Nth timer 150 closes nth switch 156 by transitioning signal S_{timedn} from a LO state to a HI state, as shown in FIG. 7. Sᵣₑₛₜₐᵣₜ transitions from a LO state to a HI state at time tₒₙ. Nth timer 150 transitions signal S_{timedn} from a LO state to a HI state nth predetermined amount of time tₙ after tₒₙ, which occurs at time t_{C} in the timing diagram shown in FIG. 7. Time t_{C} is equal to tₒₙ+nth predetermined amount of time tₙ. Nth switch 156 is closed by nth timer 150 at time t_{C}.

After a power outage occurs at time t_{off}, and then power is restored again at time tₒₙ, each timer controls a switch such that the switch associated with the timer is closed a predetermined amount of time after receiving the power restart indicator. The timing is shown in FIG. 7. In this embodiment tₙ is programmed to be a longer time than t₂, which is programmed to be a longer time than t₁. First electronic outlet 122, and any electronic device plugged into first electronic outlet 122, will receive power a first predetermined time t₁ after first timer 116 receives the power restart indicator from power detection device 118.

Second electronic outlet 142, and any electronic device plugged into second electronic outlet 142, will receive power a second predetermined amount of time t₂ after second timer 140 receives the power restart indicator from power detection device 118. In this embodiment second predetermined amount of time t₂ is longer than first predetermined amount of time t₁, so that second electronic outlet 142, and any electronic device plugged into second electronic outlet 142, will receive power later than first electronic outlet 122.

Nth electronic outlet 152, and any electronic device plugged into nth electronic outlet 152, will receive power a predetermined time tₙ after nth timer 150 receives the power restart indicator from power detection device 118. In this embodiment nth predetermined time tₙ is longer than first predetermined amount of time t₁ and second predetermined amount of time t₂, so that nth electronic outlet 152, and any electronic device plugged into nth electronic outlet 152, will receive power later than first electrical outlet 122 and second electrical outlet 142.

In some embodiments the predetermined amount of times t₁ through tₙ are the same amount of time. In some embodiment the predetermined amount of times t₁ through tₙ are different from each other. In some embodiments the predetermined amount of times t₁ through tₙ are the adjustable. In some embodiments the predetermined amount of times t₁ through tₙ are the programmable. In the embodiment of power control device 110 shown in FIG. 6 through FIG. 8, the predetermined amount of times t₁ through tₙ are different from each other, with tₙ being longer than t₂, and t₂ being longer than t₁, as shown in FIG. 7. In this embodiment the device which does not need other devices at power restart can be plugged into electrical outlet 122. The computer and modem from the home network example earlier, for example, can be plugged into electrical outlet 122. The VOIP terminal from the same example can be plugged into electrical outlet 142 or 152, and the predetermined amount of time programmed to give the computer and modem time to complete their restart sequence and obtain an internet connection before the VOIP terminal is restarted and looks to the computer and modem for the internet connection.

FIG. 9 is a front perspective view of an additional embodiment of power control device 110 according to the invention. In this embodiment power control device 110 includes two electrical outlets, first electrical outlet 122 and second electrical outlet 142, which are wall outlets mounted to a wall with wall outlet cover 170. Power control device 110 in this embodiment controls the power to each of the two wall outlets 122 and 142. Power control device 110 in this embodiment includes the elements of power control device 110 of FIG. 5, including first switch 116, power detection device 118, first timer 120, and first electrical outlet 122, where first electrical outlet 122 is a wall outlet as shown in FIG. 9. Power control device 110 of this embodiment also includes second switch 146, second timer 140, and second electrical outlet 142 as described with respect to FIG. 6. Power detection device 118, first switch 116 and second switch 146, and first timer 120 and second timer 140, are in this embodiment mounted into the electrical outlet box behind the wall that wall outlet cover 170 is mounted to. Power detection device 118 detects the power state of power input line 112, which provides power to first electrical outlet 122 when first switch 120 is closed, as discussed with respect to FIG. 5. Power input line 112 provides power to second electrical outlet 142 when second switch 146 is closed, as discussed with respect to FIG. 6. Power detection device 118 places first switch 116 and second switch 146 in the open position in response to detecting that power input line 112 is in the non-energized state. Power detection device 118 outputs a power restart indicator which takes the form of Sᵣₑₛₜₐᵣₜ transitioning from a LO state to a HI state, in response to power input line 112 transitioning from a non-energized state to an energized state, as shown in FIG. 7. First timer 120 places first switch 116 in the closed position predetermined amount of time t₁ after first timer 120 receives the power restart indicator from power detection device 118. Second timer 140 places second switch 146 in the closed position predetermined amount of time t₂ after second timer 140 receives the power restart indicator from power detection device 118. Predetermined amount of time t₁ and t₂ can be adjusted such that the power restart of the electronic devices plugged into electrical outlets 122 and 142 are timed properly with respect to each other.

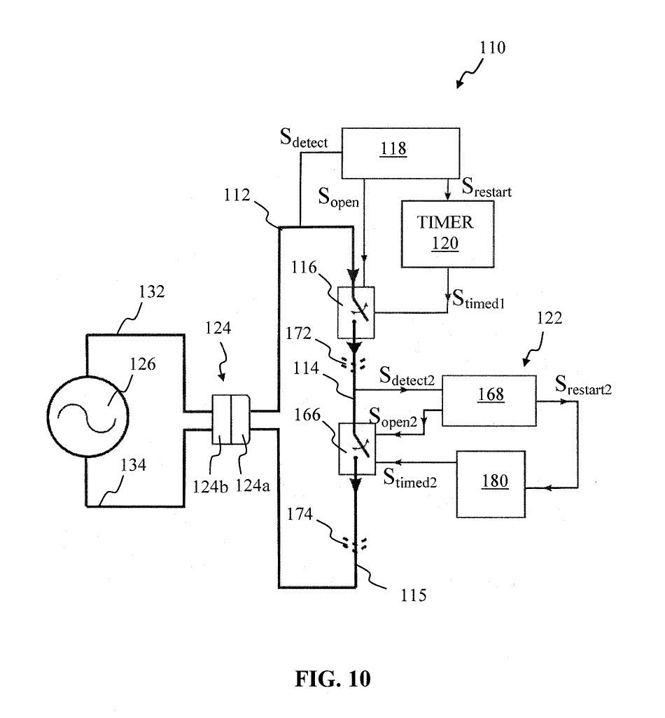

FIG. 10 illustrates a further embodiment of power control device 110 according to the invention. In this embodiment electronic device 122 is coupled to power output line 114. Power control device 110 in this embodiment includes second power detection device 168, second switch 166, and second timer 180. In the embodiment of power control device 110 shown in FIG. 6, a single power detection device 118 is used with multiple switches and timers, where the multiple switches are connected in parallel, and each switch receives power from power input line 112. In the embodiment of power control device 110 shown in FIG. 10, first switch 116 and second switch 166 are connected in series. Second switch 146 repeatably couples and decouples first power output line 114 to power return line 115. Two power detection devices are used, power detection device 118 and power detection device 168. Second power detection device 168 receives signal S_{detect2} from power output line 114. Signal S_{detect2} detects the state of power output line 114, as discussed earlier with respect to signal S_{detect}. Second power detection device 168 outputs a second power restart indicator Sᵣₑₛₜₐᵣₜ₂ in response to detecting that power output line 114 has transitioned from a non-energized state to an energized state. Second power detection device 168, second timer 180, and second switch 166 perform similar to first power detection device 118, first time 120, and first switch 116 as explained with respect to FIG. 1 through FIG. 5. Second switch 166 will be closed a second predetermined amount of time t₂ after power output line 114 receives power. In some embodiments electronic devices can be connected to power output line 114 and/or power return line 115 such that their power restart is timed in a particular sequence. In some embodiments electrical outlets can be coupled to power output line 114 and/or power return line 115. In this embodiment second power detection device 168, second timer 180, and second switch 166 do not begin their restart sequence until power output line 114 has received power from power input line 112. In some embodiments power output line 114 includes a connector, as shown in FIG. 10 with optional connector 172. In some embodiments power return line 115 includes a connector, as shown in FIG. 10 with optional connector 174.

Power control device 110 according to the invention as shown in FIG. 10 includes second switch 166, where second switch 166 repeatably electrically couples and decouples power output line 114 to power return line 115 in response to second switch 166 being in a closed or an open position, respectively. Second power detection device 168 is coupled to power output line 114, where second power detection device 168 outputs a second power restart indicator in response to second power detection device 168 detecting that power output line 114 is in the energized state. Second timer 180 is electrically coupled to second power detection device 168, where second timer 180 places second switch 166 in the closed position a second predetermined amount of time t₂ after second timer 180 receives the second power restart indicator from second power detection device 168.

Power control device 110 according to the invention can include additional switches, power detection device, and timers, coupled in series or in parallel, to create a timed power restart sequence as described.

It is to be understood that power control device 110 according to the invention can include many other devices. The embodiments shown are examples only. The timers, switches, and power detection devices can be implemented with any type of circuitry, integrated or discrete, in any form of electronic technology. Power control device 110 can be a part of an uninterruptible power supply (UPS). Power control device 110 according to the invention can be a part of any power delivery system such as a power strip, bench power, rack-mounted power system, building power, power outlets, battery system, AC power system, DC power system, or any other type of electrical power supply system. Power control device can be a part of an electronic signal delivery system. Power control device 110 can control an electronic signal delivery system.

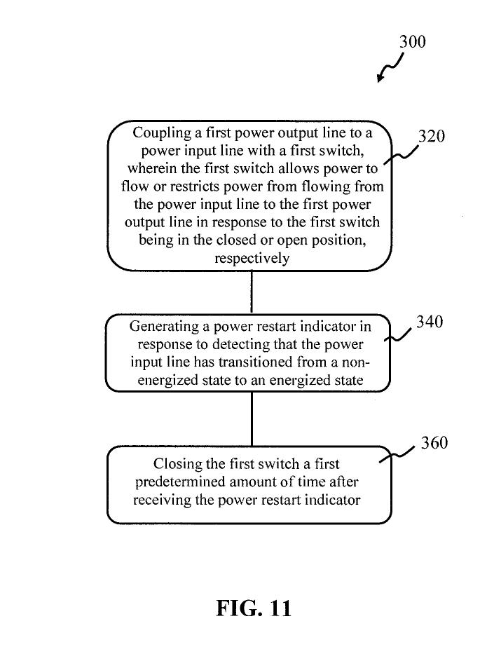

FIG. 11 illustrates method 300 of controlling power distribution according to the invention. Method 300 includes step 320 coupling a first power output line to a power input line with a first switch, wherein the first switch allows power to flow or restricts power from flowing from the power input line to the first power output line in response to the first switch being in the closed or open position, respectively. Method 300 according to the invention also includes step 340 generating a power restart indicator in response to detecting that the power input line has transitioned from a non-energized state to an energized state, and step 360 closing the first switch a first predetermined amount of time after receiving the power restart indicator.

Method 300 can include many other steps. In some embodiments method 300 includes the step of opening the first switch in response to detecting that the power input line has transitioned from an energized state to a non-energized state. In some embodiments method 300 includes the step of coupling the first power output line to an electrical device, where the electrical device receives power when the first switch is closed. In some embodiment the electrical device is an electrical outlet.

In some embodiments method 300 includes the step of coupling a second power output line to the power input line with a second switch, where the second switch allows power to flow or restricts power from flowing from the power input line to the second power output line in response to the second switch being in the closed or open position, respectively. In some embodiments method 300 also includes the step of closing the second switch a second predetermined amount of time after receiving the power restart indicator. In some embodiments method 300 includes the step of opening the second switch in response to detecting that the power input line has transitioned from an energized state to a non-energized state. In some embodiments the first predetermined amount of time is a different value than the second predetermined amount of time. In some embodiments method 300 includes the step of coupling the second power output line to a second electrical device, where the electrical device receives power when the second switch is closed. In some embodiment the electrical device is a second electrical outlet.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

1. A power control device comprising:
a power input line, wherein the power input line is in one of either an energized state or a non-energized state;
a switch, wherein the switch repeatably electrically couples and decouples the power input line to a power output line in response to the switch being in a closed or an open position, respectively;
a power detection device coupled to the power input line, wherein the power detection device outputs a power restart indicator in response to the power detection device detecting that the power input line is in the energized state;
and
a timer electrically coupled to the power detection device, wherein the timer places the switch in the closed position a predetermined amount of time after the timer receives the power restart indicator from the power detection device.

2. The device of claim 1, wherein the power detection device places the switch in the open position in response to the power detection device detecting that the power input line is in the non-energized state.

3. The device of claim 1, further comprising a power outlet coupled to the power output line.

4. The device of claim 1, wherein the predetermined amount of time is programmable.

5. The device of claim 1, further comprising an electronic device coupled to the power output line.

6. The device of claim 5, wherein the electronic device comprises:
a second switch, wherein the second switch repeatably electrically couples and decouples the power output line to a power return line in response to the second switch being in a closed or an open position, respectively;
a second power detection device coupled to the power output line, wherein the second power detection device outputs a second power restart indicator in response to the second power detection device detecting that the power output line is in an energized state;
and
a second timer electrically coupled to the second power detection device, wherein the second timer places the second switch in the closed position a second predetermined amount of time after the second timer receives the second power restart indicator from the second power detection device.

7. An electronic device comprising:
a first switch, wherein the first switch repeatably electrically couples and decouples a power input line to a first power output line in response to the first switch being in a closed or an open position, respectively;
a power detection device electrically coupled to the power input line, wherein the power detection device outputs a power restart indicator in response to the power detection device detecting that the power input line has transitioned from a non-energized state to an energized state;
and
a first timer in electrical communication with the power detection device, wherein the first timer places the first switch in the closed position a first predetermined amount of time after the first timer receives the power restart indicator from the power detection device.

8. The device of claim 7, wherein the power detection device places the first switch in the open position in response to the power detection device detecting that the power input line has transitioned from the energized state to the non-energized state.

9. The device of claim 7, wherein the first predetermined amount of time is programmable.

10. The device of claim 7, further comprising a first power outlet, wherein the first power outlet receives power from the first power output line in response to the first switch being in the closed position.

11. The device of claim 7, further comprising:
a second switch, wherein the second switch repeatably electrically couples and decouples the power input line to a second power output line in response to the second switch being in a closed or an open position, respectively;
and
a second timer in electrical communication with the power detection device, wherein the second timer places the second switch in the closed position a second predetermined amount of time after the second timer receives the power restart indicator from the power detection device.

12. The device of claim 11, wherein the power detection device places the first and the second switch in the open position in response to the power detection device detecting that the power input line has transitioned from the energized state to the non-energized state.

13. The device of claim 12, wherein the first predetermined amount of time is a different value than the second predetermined amount of time.

14. The device of claim 13, further comprising an electrical connector electrically coupled to the power input line, wherein the electrical connector repeatably electrically couples and decouples the power input line to a power source.

15. The device of claim 14 further comprising:
a first electrical outlet electrically coupled to the first power output line, wherein the first electrical outlet receives electrical power in response to the first switch being in the closed position;
and
a second electrical outlet electrically coupled to the second power output line, wherein the second electrical outlet receives electrical power in response to the second switch being in the closed position.

16. A method of controlling power distribution comprising:
coupling a first power output line to a power input line with a first switch, wherein the first switch allows power to flow or restricts power from flowing from the power input line to the first power output line in response to the first switch being in a closed or an open position, respectively;
generating a power restart indicator in response to detecting that the power input line has transitioned from a non-energized state to an energized state;
and
closing the first switch a first predetermined amount of time after receiving the power restart indicator.

17. The method of claim 16, further comprising opening the first switch in response to detecting that the power input line has transitioned from an energized state to a non-energized state.

18. The method of claim 17, further comprising coupling a second power output line to the power input line with a second switch, wherein the second switch allows power to flow or restricts power from flowing from the power input line to the second power output line in response to the second switch being in a closed or an open position, respectively.

19. The method of claim 18, further comprising closing the second switch a second predetermined amount of time after receiving the power restart indicator.

20. The method of claim 19, wherein the first predetermined amount of time is a different value than the second predetermined amount of time.
